(19) United States
(12) Patent Application Publication
(10) Pub. No.: US 2017/0084358 A1
(43) Pub. Date: Mar. 23, 2017

(54) SLOT APERTURE FOR APPLICATIONS IN RADIOGRAPHY

(71) Applicant: Bundesrepublik Deutschland, vertreten durch den Bundesminister für Wirtschaft und Energie, dieser, Berlin (DE)

(72) Inventors: Kurt Osterloh, Berlin (DE); Uwe Zscherpel, Glienicke (DE); Uwe Ewert, Teltow (DE); Norma Wrobel, Berlin (DE)

(21) Appl. No.: 15/126,366

(22) PCT Filed: Mar. 20, 2015
(86) PCT No.: PCT/EP2015/055996

§ 371 Date: Sep. 15, 2016

(30) Foreign Application Priority Data
Mar. 20, 2014 (DE) 10 2014 103 833.9

(51) Int. Cl. G21K 1/04; G01N 23/04; G01N 23/203; G21K 1/02

(52) U.S. Cl. CPC G21K 1/04; G21K 1/02; G01N 23/04; G01N 23/203

(57) ABSTRACT

The invention relates to a slot aperture, in particular for an imaging device which is suitable to delimit high-energy radiation originating from a radiation source, in particular x-rays and/or synchrotron radiation. The invention further relates to a production method for said multiple slot aperture and to a use thereof for the imaging representation of a test element.

### BACKGROUND

1. Field of the Invention

The invention relates to a slot aperture, a device for operating a slot aperture and a method for producing a slot aperture for applications in radiography.

In particular, the invention relates to a multiple slot aperture which is adapted for applications based on Compton backscattering radiography.

2. Related Art

DE 10 2005 029 674 B4 and EP 2 333 786 B1 describe a slot aperture for delimiting radiation emanating from a radiation source. Such apertures are particularly interesting for studying unknown objects which actively (gamma radiation) or passively (back-scattered) emit high-energy radiation. An investigation technique of practical importance uses inelastically back-scattered x-ray photons for image representation (radiography).

The corresponding radiography method is designated as the Compton backscattering technique. Objects which are transparent to x-ray radiation seem to virtually light up due to the back-scattered radiation. This primarily relates to organic materials and elements having a low atomic number depending on their order in the Periodic Table. X-rays are principally absorbed by elements having a high atomic number, for example heavy metals so that the scattered radiation which occurs here, if it can be detected at all, has an extremely low intensity.

This circumstance can be used to produce comparatively high-resolution images, for example, for requirements of a safety examination or for non-destructive material testing when an adapted aperture is used.

The said apertures are comparatively massive according to the requirements imposed on them. Measurement arrangements such as, for example imaging devices constructed according to the pinhole camera principle comprising a slot aperture can therefore only be used as mobile to a limited extent, if at all. In addition, as a result of the high requirements on the quality of inner surfaces of the aperture, methods suitable for producing the slot aperture are typically complex and costly.

### SUMMARY

In view of the related art, the following objects are posed:
1. on the one hand to image a radiating body as sharply as possible and/or on the other hand to obtain image information about the structure of an unknown object which cannot be detected by a single beam by means of a backscattering technique;
2. to broaden the imaging surface by using a new type of screen (the multiple slot aperture proposed here) and provide suitable methods for producing the screen;
3. to provide an aperture device which is as compact (light) as possible and nevertheless stops down reliably, whose slot width is adjustable;
4. to provide a device for mechanical adjustment of the slot width
5. to prevent the parallel passage of rays through the aperture and suppress a superposition of multiple recordings.

Against this background, a slot aperture is proposed according to claim 1, a method for producing a slot aperture according to claim 16 and the use of the proposed slot aperture for imaging representation by means of high-energy radiation according to claim 21, an image generating method with the assistance of said slot aperture according to claim 22 and an imaging device comprising the said slot aperture according to claim 24. Further advantageous configurations, details and features of the present invention are obtained from the subclaims, the description and the exemplary embodiments.

According to a first embodiment, a slot aperture in particular for an imaging device which is suitable for delimiting high-energy radiation emanating from a radiation source, in particular x-ray, gamma and/or synchrotron radiation, comprising a first slot block and a second slot block is proposed, wherein the first and the second slot block comprises a radiation-absorbing part and at least one radiation-transmitting part and the first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block and in a second position the slot of the first slot block points towards a slot-free region of the second slot block so that a radiation beam running through the first slot of the first slot block impinges upon a region of the second slot block adjacent to the corresponding slot and thus does not pass through the second slot block. Thus, in the first block the entire passage channel for the passing beam is delimited from above and secondly from below.

Advantages of this embodiment consist on the one hand in a simplified manufacture of a slot aperture with a plurality of slots (multiple slot aperture), primarily in a simple mode of construction of an aperture which comprises two plates which are displaceable with respect to one another and have at least one slot. The resulting aperture is substantially lighter, requires a smaller material input than known apertures and is therefore easier to transport and/or can be used as mobile. According to preferred embodiments, the slot aperture comprises at least one, for example 3, typically 5 or more radiation-transmitting slots. An advantage of the presence of a plurality of slots is obtained from the expanded field of view for the recordings compared with a single slot. At the same time, the resolution is improved by a narrower slot at the expense of the width of the field of view. Depending on the given measurement situation or formulation of the problem, a selection can then be made between an increased image sharpness with reduced slot width and an increasing width of the field of view (image width) with increased slot width (wide opening).

According to a further embodiment, the second position of the arrangement of the two slot blocks as proposed corresponds to a parallel shift of the slot of the first slot block to that of the second slot block.

This yields advantages for the reproducibility of the aperture setting and the design of the device with the aid of which such a shift is achieved.

According to a further embodiment, an adjoining surface region between the first and an adjacent second slot of the second slot block at least has a shape which is obtained from a projection of the cross-sectional area of the first slot of the first slot block onto the surface of the second slot block facing the first slot block.

This advantageously yields the possibility of an opening without shearing the beam channel and a defect-free enlargement or narrowing of the effective aperture width.

According to a further embodiment, one slot of the proposed slot aperture comprises at least two opposite walls of at least identical shape in sections. The said two walls lie opposite one another inside the slot block.

Advantageously the two walls therefore form a plane-parallel encasing of a radiation beam so that a radiation beam entering into the slot on one side of the slot block can leave the slot block on the other opposite side unattenuated.

According to a further embodiment, at least one of the walls of the proposed slot aperture comprises a metal sheet.

Advantages are obtained from the simplified manufacture of the walls, in particular since metal sheets can be brought into identical form comparatively easily.

According to a further embodiment, a slot aperture is proposed, wherein the metal sheet is selected from: aluminium, bronze, iron, copper, brass, nickel steel, titanium, tungsten or an alloy comprising at least one of the elements: Al, Be, Pb, Cu, Cr, Fe, Ni, Sn, Ti, W, Zn. When a thin metal sheet measured by the mass of the aperture was involved, the choice of the material for the metal sheet would then lose importance but the “main load” of the shielding would be taken over by the filling material between the limiting metal sheets of the slots.

Advantages of these elements comprise the availability of metal sheets comprising pure metals or alloys of these elements as well as the respective atomic number of these elements which substantiates their suitability as an absorber of high-energy radiation. As a result of the choice of materials and in the interests of a portable embodiment of the aperture, the slot aperture is adapted for application with high-energy radiation in the range of 50 to 1000 keV, in particular in the range of up to 500 keV, preferably for radiation energies below 400 keV.

According to a further embodiment, a slot aperture is proposed, wherein the radiation-absorbing part comprises lead which is arranged between the walls of adjacent slots.

Advantages of lead as an absorber of high-energy radiation are applicable. The lead sheet metal can also be formed easily.

According to a further embodiment, a slot aperture is proposed, wherein a first wall comprises a first metal sheet having approximately the maximum possible gap width from the thickness, which has a higher absorption capacity for the high-energy radiation that a metal sheet which is comprised by a second wall.

Advantages of this embodiment are obtained from the fact that during closure of the slot aperture, one of the two walls of the slot of one slot block is exposed to the unattenuated radiation of the radiation beam passing through the corresponding slot in the opposite slot block. The described embodiment ensures a reliable shielding effect despite the barrier which is only half as thick created by the slot aperture material of only one slot block in the region of the radiation bundle.

According to a further embodiment, a slot aperture is proposed, wherein a thickness and/or a profile of the first metal sheet of the slot in the first block at least comprises a thickness and/or a profile of the corresponding slot in the second slot block and a thickness and/or a profile of the second metal sheet of the slot in the second slot block at least comprises a thickness and/or a profile of the corresponding slot in the first slot block.

Advantages are obtained in particular for an adjustable quality of the beam projection or imaging, i.e. either high radiation passage dose at the expense of the image sharpness or a sharp image at the expense of the intensity, similarly to the aperture setting on a normal camera where depth of field is involved.

According to a further embodiment, a slot aperture is proposed, wherein at least two of the slots of the same slot block have an identical cross-sectional area and/or shape.

The advantages of this embodiment correspond to the aforesaid advantages. In particular, the arrangement of self-similar slots—the previously designated embodiment should not be described otherwise—allows a high magnified imaging area.

According to a further embodiment, a slot aperture is proposed, wherein planes defined by the slots in the first slot block intersect one another in a line which lies outside the first slot block on a side facing the second slot block.

For more effective shielding of high-energy radiation in the slot region in the (partially) closed position by corresponding displacement of the front and rear aperture halves with respect to one another, a denser material than that of the remaining aperture body is proposed for the cladding. Each beam which does not pass through a slot is shielded by the aperture in its entire layer thickness. That which in a closed position passes the front aperture half through a slot can only be shielded by the advanced part of the rear half (cf. shaded areas in FIG. 6). In order to compensate for the lack of layer thickness to the entire aperture thickness, a denser material is proposed in this region. For example, if the aperture body consists of copper or brass, then tungsten is a suitable material for this region.

According to a further embodiment, an imaging device is proposed comprising an imaging device comprising a slot aperture, wherein the high-energy radiation lies in the range of 50 keV to 20 MeV (including high-energy gamma emitters such as ⁶⁰Co etc.), for example in the range of 150 keV to 1000 keV, typically in the range of 100 keV to 450 keV.

Advantageously the energy of high-energy gamma emitters such as, for example, ⁶⁰Co, ¹³⁷Cs, ¹⁹²Ir etc. lies within the specified range. The energy range of commercially available x-ray tubes typically lies between 100 keV and 40 keV so that the imaging device is suitable for use with commercially available x-ray tubes and in its specific structural design (design) can be adapted to the particular measurement situation. Advantageously the relevant technical staff who are concerned with the recording of images of relevant objects are also qualified for dealing with commercially available x-ray tubes or radiation sources.

According to a further embodiment, an imaging device is proposed wherein a shielding thickness of the slot aperture is adapted to an energy range of the high-energy radiation of up to about 300 keV. The range designated with “about” should cover 300 keV±50 keV. According to a practical embodiment, only ⅕ of the shielding thickness of the shielding thickness is required there compared with high-energy radiation having an energy of around 1 MeV.

From this it advantageously follows that, for example, when using tungsten as shielding material, the wall thickness of the imaging device can be reduced from 5 cm to 1 cm. This results in a weight reduction of the imaging device by 80% independently of the shielding material. As can be seen, this weight reduction is appreciable and considerably improves the transportability and mobile usability of the device. For example, an imaging device reduced to an overall mass of about 30 kg compared with a device weighing 150 kg can be handled by only a single person. Alternatively to a reduction in scale, the originally selected width of the slot aperture is retained. The weight reduction is therefore achieved merely by a reduction in the wall thickness where the overall recording geometry known from the thick-walled embodiment is fundamentally retained.

According to a further embodiment, a preferred range of the slot width adjustment is between 1 mm and 7 mm. Here depending on the measurement situation and the objective, the person skilled in the art will weigh up between an increased image sharpness with a small slot, or a small slot and a desired maximum width (height) of the image (wide opening or wide gap). A preferred slot width can be varied, for example, between 0.5 mm and 10 mm. Likewise, the at least one gap (or synchronously all the gaps) can be fixedly adjusted by a relative movement of the first slot block and the second slot block relative to one another between 0.75 mm and 8 mm or between 1 mm and 7 mm, optionally also between 2 mm and 5 mm. In this case, a precision of the adjustment is typically ±0.01 mm or ±0.1 mm, for example, ±0.25 mm. Optionally required drives for automatic adjustment of the desired gap width, for example a step motor (e.g. tooth belt drive step motor) are known to the person skilled in the art. In addition, by means of suitable dimensioning of the gearwheels 5, 7 and 8 or the chain 6 used in the transmission, the slot width can also be adjusted manually with the required precision, for example, with the aid of a crank which can be suitably connected to a drive stage. The respective gap width is obtained—with previous calibration—from an adjusted angle of the crank.

According to a further embodiment, a method of manufacture for a slot aperture for high-energy radiation as described previously is proposed comprising the following steps:
forming at least two metal sheets on an initial shaped body;
equidistant connection of respectively two metal sheets to one another so that the interconnected metal sheets form a channel, wherein the channel comprises a first open end and a second open end opposite thereto;
arranging and aligning the channel in a casting mould;
filling the casting mould with a lead-containing melt in such a manner that the channel is not filled with the melt;
removing a casting comprising the channel obtained in the casting mould.

It is advantageous in this method of manufacture compared with the known method of manufacture that a predefined slot shape of a slot block can be produced additively to a certain extent. It is substantially more complex to produce a slot having the required properties (for example, plane-parallel wall sections, surface quality etc.) by machining methods in a solid material than to encase a slot formed substantially with two metal sheets with the melt of the solid material.

According to a further embodiment, a method of manufacture for a slot aperture for high-energy radiation as described previously is proposed comprising the step of “truing the casting body to a slot block”.

Advantages of this embodiment are obtained in that burrs caused by the casting technology and/or support structures or material excesses can be removed with only a few working steps.

According to a further embodiment, the proposed method of manufacture comprises the step:—adapting and aligning a first and a second slot block so that in a first position of the slot blocks with respect to one another, the at least one slot arranged in the first slot block is continued in precisely one corresponding slot arranged in the second slot block so that a radiation beam running through the first slot of the first slot block passes unhindered through the second slot block and in a second position, the slot of the first slot block points towards a slot-free region of the second slot block so that a radiation beam running through the first slot of the first slot block impinges upon a region of the second slot block adjacent to the corresponding slot and thus does not pass through the second slot block.

Advantages of this embodiment are obtained from the assembly of the slot aperture from the two essential components forming them: the first and the second slot block.

According to a further embodiment, the proposed method of manufacture comprises the step:—providing a drive for a gradual change between the first and the second position so that a resulting power of a radiation beam passing through the first and the second slot block can be adjusted as required.

Advantages are obtained from the thus attainable precision of the adjustment of the aperture. In particular when the slot width is narrowed, some of the radiation is only shielded by the barrier layer of one of the blocks but all the other non-passing fractions are shielded by the material of both aperture parts. Thus, this barrier layer can be made from a more strongly absorbing material. A possible material combination can, for example, constitute copper or brass for the aperture body and tungsten for the barrier layer.

According to a further embodiment, the proposed method of manufacture comprises the step:—arranging an image acquisition system on one side of a slot block so that a radiation beam passing through the slot aperture impinges upon a detecting surface of the image acquisition unit.

Typical advantages of this embodiment relate to the mobile usability of the arrangement for imaging interesting objects of investigation. As a result of the independence of the operating mode of a portable slot aperture camera on the irradiation geometry with the x-ray emitter, recordings can successfully be made which had hitherto not been possible with conventional x-ray backscattering methods. The backscattering behaviour of individual material layers in the object can be controlled by specific irradiation. Thus, it is possible to present radiation-passive structural elements independently of the laboratory environment as a silhouette against an emitting background. This is particularly important for applications with a safety-technology background.

According to a further embodiment, the use of a slot aperture, described previously for example, for the imaging representation of a test specimen by means of exposure to high-energy radiation is proposed, wherein a radiation source of high-energy radiation, a test specimen and a slot aperture are arranged so that fractions of the high-energy radiation backscattered by the test specimen impinge upon an image acquisition unit and/or on a detector through the slot aperture.

Advantages of using the described slot aperture are obtained from the already described advantages of the proposed device. They relate in particular to the possibility for comparatively clear imaging by means of Compton backscattering of a weakly absorbing component against the background of a strongly absorbing component. Assumed is a separate illumination of the region behind the strongly absorbing component in the object by appropriate collimation of x-ray radiation incident in the object laterally obliquely to the viewing direction of the camera. Thus, an emitting background is produced against which an absorbing component then stands out as a silhouette. Such an imaging geometry cannot be achieved with any other x-ray backscattering device.

According to a further embodiment, an image-generating device for non-destructive material testing of an object with high-energy radiation, in particular with x-ray, gamma and/or synchrotron radiation is proposed. The image-generating method comprises the steps: providing an imaging device comprising a slot aperture according to at least one of the previous embodiments; arranging the imaging device and the object so that high-energy radiation emanating from and/or backscattered by the object is incident through the slot aperture onto the detector of the imaging device; and adjusting a slot width of the slot aperture of the imaging device with regard to a beam intensity so that at the adjusted slot width a fraction of the high-energy radiation emanating from and/or backscattered by the object, suitable for generating an image, is guided onto the detector.

Advantages of this embodiment are obtained with satisfying a need for reliable methods for non-destructive material testing, for example, in the field of composite materials, which exploit the advantages of an imaging investigation with high-energy radiation. As described, the image acquisition can be accomplished with an adapted mobile device on site. Applications range from vehicle manufacture (automobile construction, aircraft, rail vehicles) via the construction and monitoring of wind energy systems as far as applications in the field of the protection of art and cultural property (renovation) and also relate directly to safety technology aspects (storage of hazardous goods; customs control).

According to a special embodiment, the image-generating method comprises the inspection of a composite material, where the non-destructive material testing allows detection of an inclusion and/or an inhomogeneity in the composite material.

Advantageously inclusions and/or inhomogeneities deliver particularly readily detectable signals so that such particularly critical structures for a failure behaviour can be detected unequivocally.

According to a further embodiment, an imaging device is proposed comprising a slot aperture with at least one radiation-transmitting slot and a detector, wherein high-energy radiation, in particular x-ray, gamma and/or synchrotron radiation can be adapted with regard to a beam intensity by means of an adjustable slot width of the at least one radiation-transmitting slot so that at the adjusted slot width high-energy radiation emanating from an actively emitting object and/or backscattered by an unknown object guides a fraction of the high-energy radiation suitable for generating an image through the slot aperture onto the detector, wherein the slot aperture comprises a first slot block and a second slot block which each comprise a radiation-absorbing part and at least one radiation-transmitting slot and the first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block and in a second position the slot of the first slot block points towards a slot-free region of the second slot block so that a radiation beam running through the first slot of the first slot block impinges upon a region of the second slot block adjacent to the corresponding slot and thus does not pass through the second slot block. Thus, in the first slot block the entire passage channel for a passing beam is delimited on one side, for example from above (or for example from the left) and in the second opposite side, for example, from below (or for example from the right).

Advantages of this embodiment consist on the one hand in a simplified manufacture of a slot aperture with a plurality of slots (multiple slot aperture), primarily in a simple mode of construction of an aperture which comprises two plates which are displaceable with respect to one another and have at least one slot. The resulting aperture is substantially lighter, requires a smaller material input than known apertures and is therefore easier to transport and/or can be used as mobile. According to preferred embodiments, the slot aperture comprises at least one, for example 3, typically 5 or more radiation-transmitting slots. An advantage of the presence of a plurality of slots is obtained from the expanded field of view for the recordings compared with a single slot. At the same time, the resolution is improved by a narrower slot at the expense of the width of the field of view. Depending on the given measurement situation or formulation of the problem, a selection can then be made between an increased image sharpness with reduced slot width and an increasing width of the field of view (image width) with increased slot width (wide opening).

According to a further embodiment, the slot of the proposed imaging device comprises at least two opposite walls of identical shape at least in sections. The said two walls lie opposite one another within the respective slot block.

Advantageously the two walls therefore form a plane-parallel encasing of a radiation beam in sections so that a radiation beam entering into the slot on one side of the slot block can leave the slot block on the other opposite side and impinges upon the detector unattenuated whereby a high image quality can be achieved.

According to further embodiments, it is proposed to fabricate at least one of the described slot blocks using an alternative method of manufacture where the method of manufacture is based on a 3D printing method. A suitable 3D printing method typically comprises a layered sintering of a fine-particle metal powder, for example with the aid of a laser beam which is guided in layers according to a respective cross-section of the designed slot block over a metal powder bed. For example, the lead-based powder can easily be formed into complex spatial structures by means of sintering. Another suitable 3D printing method can be implemented with the aid of a metal wire, e.g. a wire comprising a lead-containing alloy—similar to established 3D melt printing methods using a plastic strand. 3D printing methods intended for the fabrication of complex spatial structures are particularly suitable for producing the slots in the slot plate which are present as defined cavities (undercuts) in solid material. For both the 3D printing methods described here, knowhow from the technical field of manufacturing solders, in particular solder pastes and corresponding metal powder, can be used as the basis with regard to the materials which can be used for 3D printing.

The previously described embodiments can be arbitrarily combined with one another.

### BRIEF DESCRIPTION OF THE DRAWINGS

The appended drawings illustrate embodiment and together with the description serve to explain the principles of the invention. The elements of the drawings are relative to one another and not necessarily true to scale. The same reference numbers accordingly designate similar parts. In the figures:

FIG. 1A shows a usual arrangement according to the prior art of an image acquisition unit for investigating an object by means of Compton backscattering by “scanning with a pencil beam”

FIG. 1B shows the principle of the imaging of an object pursued here by means of Compton backscattering by total irradiation (field illumination) of the object being studied

FIG. 2 shows a scheme for the configuration of an aperture body composed of several materials starting from a solid aperture body;

FIG. 3 shows the reduction of the shapes of different slot profiles in a multiple slot aperture to a common initial shape;

FIG. 4 shows steps from a solid multiple slot aperture to the variably adjustable version;

FIG. 5 shows half-apertures in plan view with one (of several possible) slot profiles front (black) and rear (grey) in the “closed” position (left) and in the open position (right);

FIG. 6 Half-apertures of simplified shape for a holder in which steeply incident radiation is absorbed by a corresponding frame. The closed position of the apertures is shown in the left half-image, the open position after a corresponding downwards movement of the right half-body is shown in the right half-image;

FIG. 7 shows the use of construction materials of different density for more effective shielding in the closed part of the beam path;

FIG. 8 shows the formation of a trapezoidal aperture body with its narrow side to the object so that the beams incident through the aperture intersect in front of the aperture in a perpendicular axis;

FIG. 9 shows a side view of a mechanical mover for adjustment of the slot width of a multiple slot aperture;

FIG. 10 shows a view from above of a possible mounting of a multiple slot aperture in a housing which can be installed in a “lead castle” with lead bricks (“dovetails”),

FIG. 11 shows the view from below of the drive of the slot adjustment with adjusting wheels, the axes of the mover rod and its connection via a drive chain shown in FIG. 10;

FIG. 12 shows a perspective view of a slot aperture for an embodiment with reduced mass, where only one slot is shown as an example.

### DETAILED DESCRIPTION

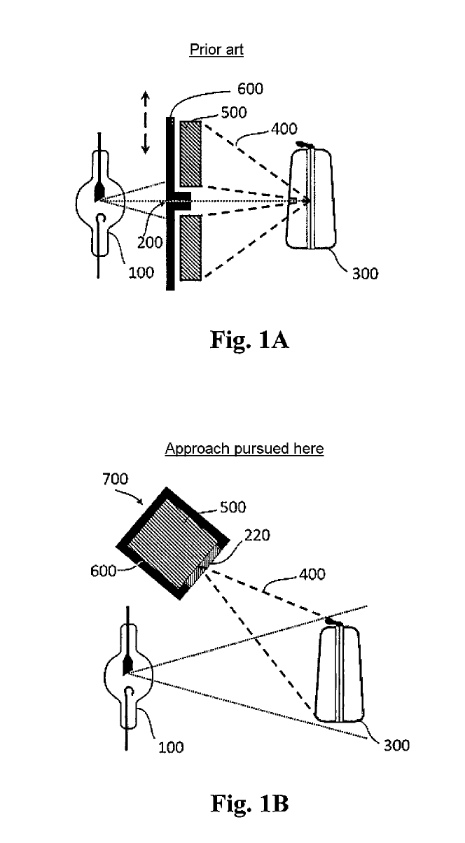

In particular, FIG. 1A shows an arrangement typically used according to the prior art for investigating an object by means of Compton backscattering. X-ray radiation emanating from an x-ray tube 100 used as a radiation source is directed through a pinhole aperture 200 onto the object 300 to be investigated. The x-ray radiation is guided onto the object 300 as a “pencil beam”. Typically the object (cf. perpendicular arrow on the left in FIG. 1A) is scanned by means of point illumination. Compton radiation 400 backscattered by the surface, optionally from the depth of the object, is detected by a detection unit 500 and converted by means of suitable methods into image information (for example, by means of an x-ray fluorescence film, array detector etc.). A screen 600 is used to protect against external exposure/radiation.

In contrast to this according to the approach pursued as shown in overview form in FIG. 1B, using a slot aperture 220 the x-ray radiation 400 backscattered by the object can be used directly for imaging. The slot aperture 220 is part of a camera 700 which comprises a shield 600 enclosing the detection unit 500.

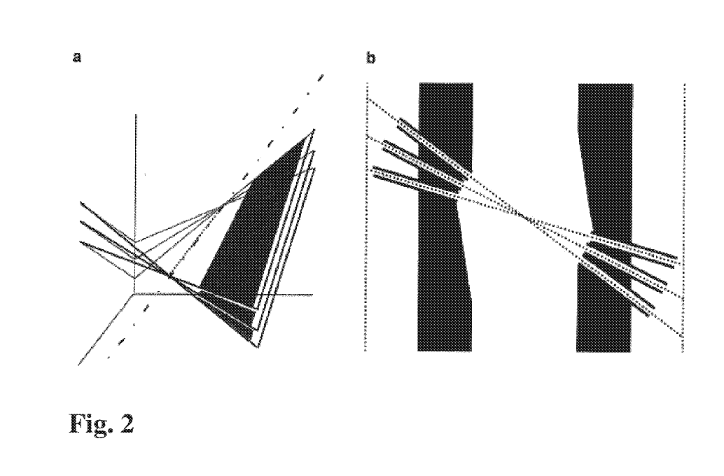

FIG. 2 shows schematically the transition from a solid aperture body to an aperture body composed of a plurality of materials. Here the partial image a) shows the profile of three slot courses with their common central axis (dash-dot line). The implementation of this concept in a solid aperture body has been described previously (EP 2333786 B1). According to the invention, an absorbing aperture body need not enclose the beam path of the high-energy radiation through the depicted slot profiles over the entire length but partial regions such as, for example, the areas shown grey, are sufficient as long as the required shielding thickness is retained. The partial image b) accordingly shows an arrangement of metal sheets which enclose the slot profiles where a high-density absorbing material is incorporated between metal sheets of adjacent slot profiles. The shaping metal sheets themselves do not need to absorb as strongly as the material incorporated between them so that the shielding is ensured by the denser material incorporated between adjacent metal sheets.

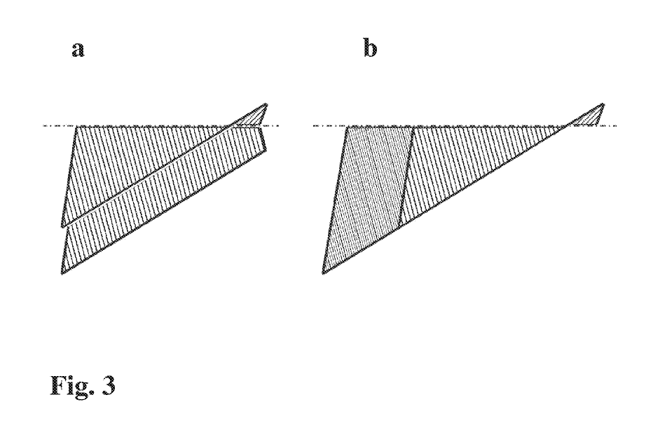

FIG. 3 shows how the shapes of different slot profiles in a multiple slot aperture can be reduced to a common initial shape (master mould). The partial image 3a) shows two superposed slot profiles which are aligned onto a common central axis (dot-dash, transverse to beam direction). The slot profiles can each be covered by a metal sheet at the top and bottom or directly adjoin a metal sheet. The partial image 3b) shows the transfer of the lower slot profile (shown darker) into a common plane with the upper one by a simple left shift. The walls surrounding the slots made of a metal sheet can thus be made for all slot profiles from a common master mould, e.g. by stamping the metal sheets with the same stamp. Metal sheets for encasing the slot profiles in the individual layers can then be correspondingly cut from this “original mould” which is naturally broader than the individual slot profiles by simply trimming.

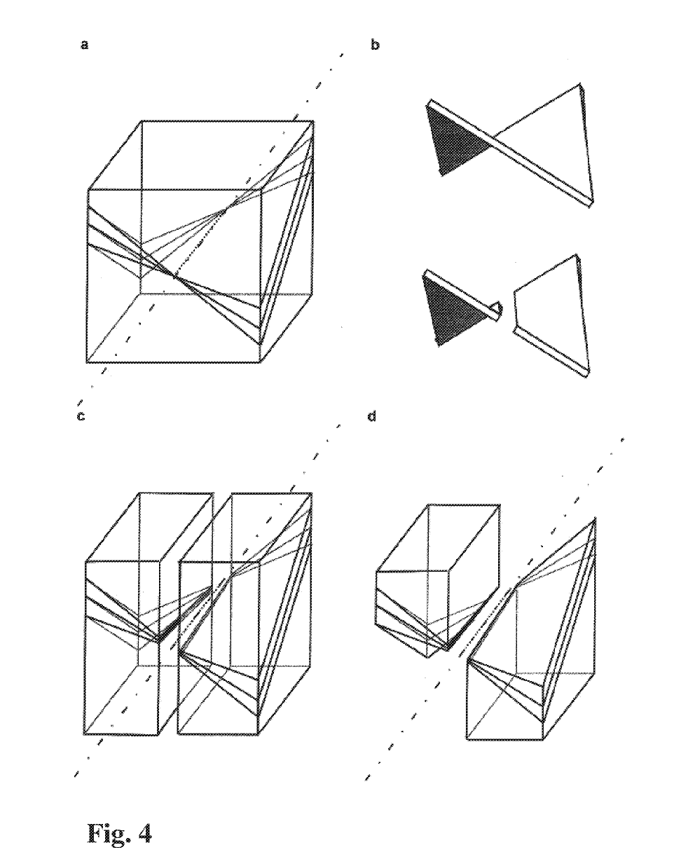

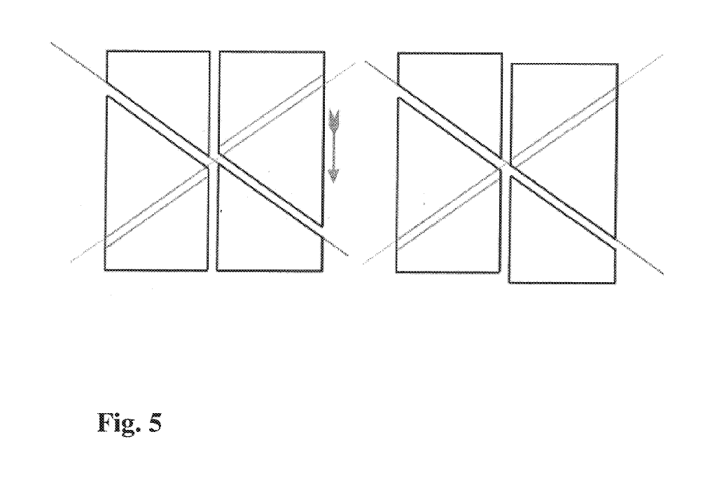

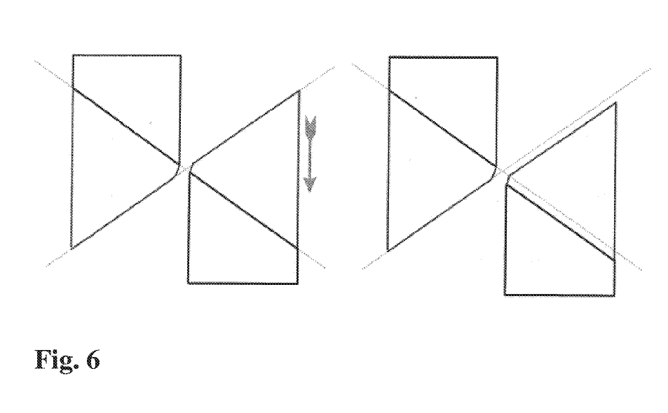

FIG. 4 shows in steps the transition from a fixedly adjusted or fixed multiple slot aperture to the variably adjustable multiple slot aperture proposed here. The partial image a) shows a multiple slot aperture in the block as described previously in EP 2333786. The partial image b) shows the interruption of the slot (upper partial image) approximately at its centre (lower partial image) where the beam path itself remains uninfluenced. The partial image c) shows the division of the solid multiple slot aperture into two half-apertures. The partial image d) illustrates the reduction of the aperture mass. Further explanations on this matter are given in the description of FIGS. 5 and 6.

FIG. 5 shows the two half-apertures from FIG. 4c in plan view with one of several possible slot profiles. In the left partial image the slot profile of a closed aperture is shown black in the image foreground whereas its rear part covered by the aperture body (in the image background) is shown grey. The closed state of the aperture is illustrated whereby the grey dotted line running from top left to bottom right runs along the upper side of the slot in the left slot block and along the underside of the corresponding slot in the right slot block. A direct passage of the beam through the aperture is therefore not possible, the aperture is closed. Each beam through the interior of the slot in one of the two partial bodies designed as slot blocks is blocked by the other partial body or the corresponding second slot block. In the right partial image the aperture is shown in the open position after the right slot block has been moved downwards by about one gap width. The required shielding in the closed state of the aperture is only accomplished by the layer thickness of one of the two slot blocks. This aspect is pursued in the following FIG. 6.

In particular, FIG. 6 shows two half-apertures in simplified form provided for holders in which steeply incident radiation can be absorbed by a corresponding frame of the holder. The closed position is shown in the left partial image, the open position in the right partial image is obtained after a corresponding downwards movement of the right partial body. The shielding layer of the respectively removed parts of the half-apertures can be transferred into the holder which in any case also takes on the shielding function in the regions outside the aperture body.

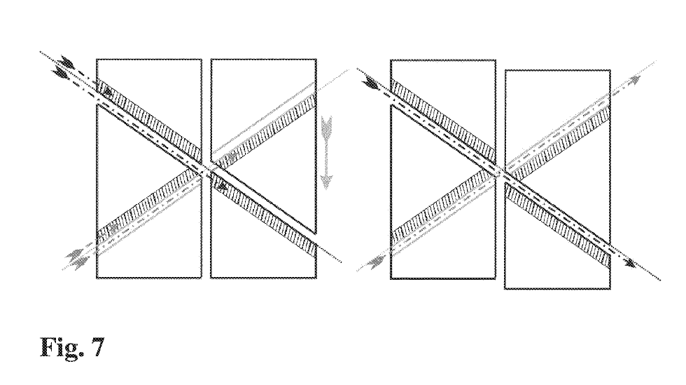

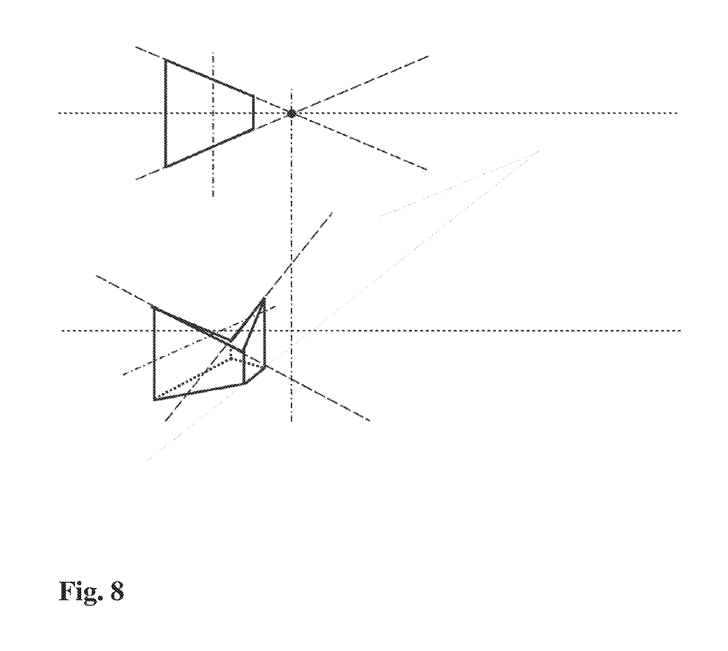

FIG. 7 illustrates the use of materials of different density for more effective shielding in the closed part of the beam path of the proposed aperture. The diagrams of the closed (left) and the open aperture position (right) from FIG. 5 are supplemented by the transmitted and absorbed beams and those parts which can advantageously be made of denser material (cf. FIG. 8, shaded areas along the slot openings). In the closed position (left), the beams pass through the first slot block (first partial aperture) and are only absorbed in the second slot block. In addition, only that part of the first slot block which is located in the linear direction in front of the slot in the second is available for beam absorption. These parts of the aperture body are emphasized in grey. They can be made of denser material to compensate for the lack of layer thicknesses. Whereas the aperture bodies can be made of copper or brass, tungsten, for example, can serve as denser material. The right partial image shows the aperture in the (completely) open position with the transmitted beams (dot-dash line).

Whereas in the preceding figures the object to be imaged is typically located behind the screen, FIG. 8 shows an arrangement of the aperture to the object in which the object is in front of the aperture and the imaging plane is therefore located behind the aperture: this therefore shows the beam profile through the trapezoidal slot aperture in “reverse” alignment. The aperture is here aligned with its narrow side towards the object so that the beams intersect in front of the aperture in a perpendicular axis. This arrangement brings specific advantages for multiple slot aperture arrangements and was specially devised to compensate for the existing disadvantages of a strictly parallel slot arrangement (cf. the documents cited in Paragraphs [0003] and [0052]). FIG. 8 shows only one slot of a plurality of superposed slots. A diagrammatic depiction of the plurality of slots arranged in the aperture runs the risk of becoming unclear and therefore incomprehensible which is why the selection shown here has only one slot. However, this selection expressly does not constitute dispensing with an embodiment having typically a plurality of superposed slots. According to preferred embodiments, the multiple slot aperture proposed here comprises at least one, for example 3, typically 5 or more, for example, 7, 8 or 9 slots.

The original purpose of the trapezoidal multiple slot aperture shape was to increase the viewing angle (EP 2 333 786 B1, PCT WO 2011/069770 A). Thus, a position of the image plane in front of the point of intersection of the leg extensions of the trapezoidal shape was obtained. In the shape now proposed a different aim is pursued. Since in a multiple arrangement of parallel slots, i.e. a narrow arrangement of non-trapezoidally shaped wide slots, a superposition of parallel images can be determined (DE 10 2008 025 109 A1, EP 2 124 231 A2), in order to eliminate this deficiency the trapezoidal shape is now proposed in the arrangement shown here. The extended legs of the trapezoidal base shape now reach the side of the aperture facing the object and there form a second “focal axis” which lies perpendicular to the first inside the aperture. It is thus avoided that beams impinging parallel upon the aperture body can simultaneously impinge upon the image surface through adjacent slots. As a result, the image quality is improved substantially since the perturbing superposition of parallel images is avoided.

In the upper part the aperture can be seen in plan view (from above). The central axis is shown by a short-dashed line and the outermost lateral beam profile is shown by a long-dashed line. A dot-dash line which runs through the aperture body shows the resulting common axis of intersection of all the beams which pass through the aperture slot. As a result of the trapezoidal shape of the aperture body, a second axis of intersection is obtained in front of the aperture perpendicular to that shown as a solid point and running perpendicular to the plane of the image.

The dot-dash line through this point forms the connection to the lower partial image which shows a perspective side view of the aperture body. The same axis identification as previously applies and the vanishing point is indicated by the ultrathin dashed rays. As a result of the simplification, only the lower part of the aperture body is shown in the lower partial image. The outermost lateral beams run on the edges of this body and intersect the dot-dash axis of intersection in front of the aperture in the manner shown in the upper partial image (in the plan view). Thereafter they diverge again. Thus, two axes of intersection (shown by dot-dash lines) are present in the beam profile, one in the slot of the aperture and another perpendicular thereto in front thereof.

An advantage of these embodiments consists in that multiple images formed as a result of the quasi-parallel slots and superposed on one another are avoided. For an image of the object however, the distance of the object to the aperture (object distance) must be significantly greater than the distance of the perpendicular axis of intersection to the aperture. According to preferred embodiments, the object distance for example is at least 1.5 times, preferably twice or a multiple of the distance of the perpendicular axis of intersection to the side of the slot block (aperture) aligned towards the object.

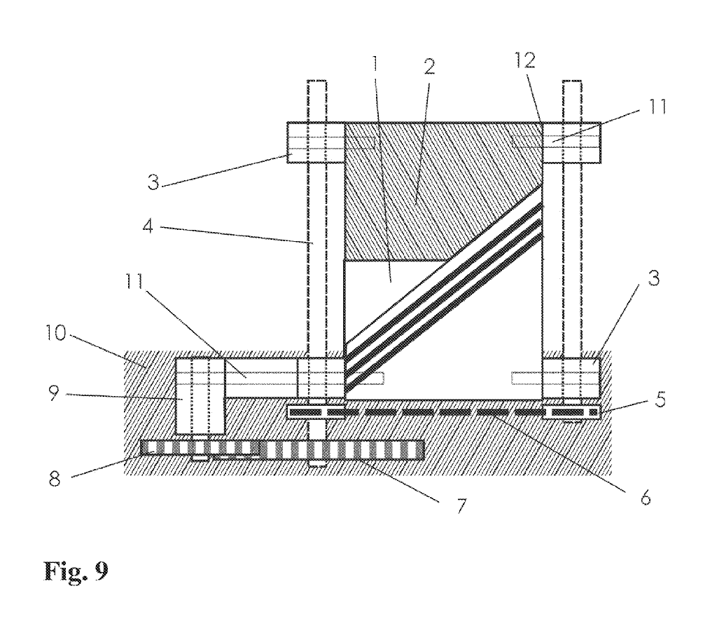

According to preferred embodiments, the adjustment of the aperture is made with the aid of a mechanical mover, for example, with the aid of an electrically operated drive. FIG. 9 shows a side view of a mechanical mover for adjustment of the slot width of a multiple slot aperture. A simplified form of partial apertures is shown here as shown in FIG. 6. However, more slots can be provided above and below.

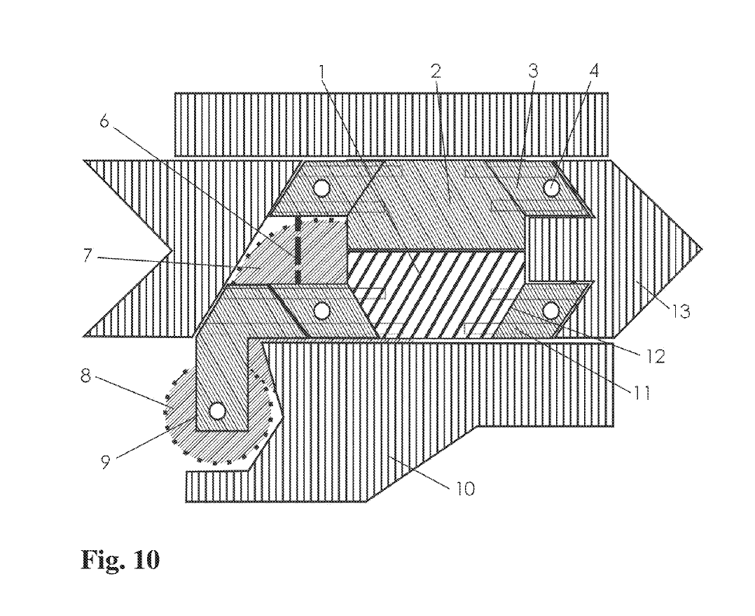

FIG. 10 shows a plan view or a view from above of a possible mounting of a multiple slot aperture in a housing which can be installed in a usual shielding (“lead castle”) composed of individual lead bricks so-called “dovetails”. A contrary movement of the partial apertures can be achieved, for example, by opposite screw threads in the drive rods.

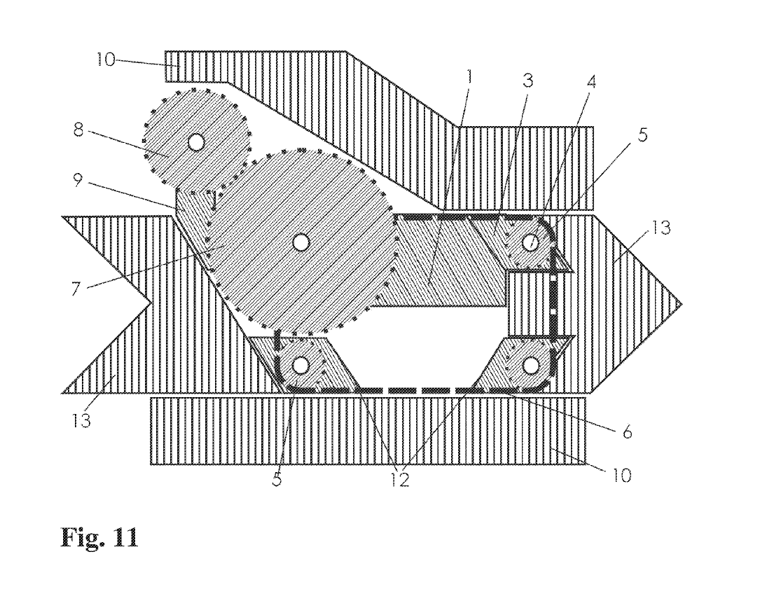

Finally FIG. 11 shows a view from below of the drive of the slot adjustment with adjusting wheels, the axes of the mover rod and its connection via a drive chain.

Here as in all FIGS. 9 to 11, the reference numbers designate the following components:
1 Front partial aperture viewed in the direction of the adjusting wheel for adjustment of the slot width;
2 Rear partial aperture;
3 Aperture holders with internal threads for the adjustment drive, with opposite threads for the respective partial apertures;
4 Axes of the drive rods for the adjustment;
5 Gear wheels on the axes of the rods for the adjusting drive;
6 Connecting chain between all axes for the adjustment;
7 Large gear wheel on the left front axis for the adjustment mover rod as connection to the adjusting wheel;
8 Adjusting wheel;
9 Holder for the adjusting wheel;
10 Front shielding over the adjusting mechanism, overlapping with the actual aperture;
11 Connecting screws between apertures and holder, transverse to the beam direction to avoid leaks);
12 Obliquely running front faces between aperture body and holders to avoid points of passage for radiation (avoidance of leaks);
13 Part of the aperture housing, configured here for installation in an experimental overall housing for a camera with lead bricks.

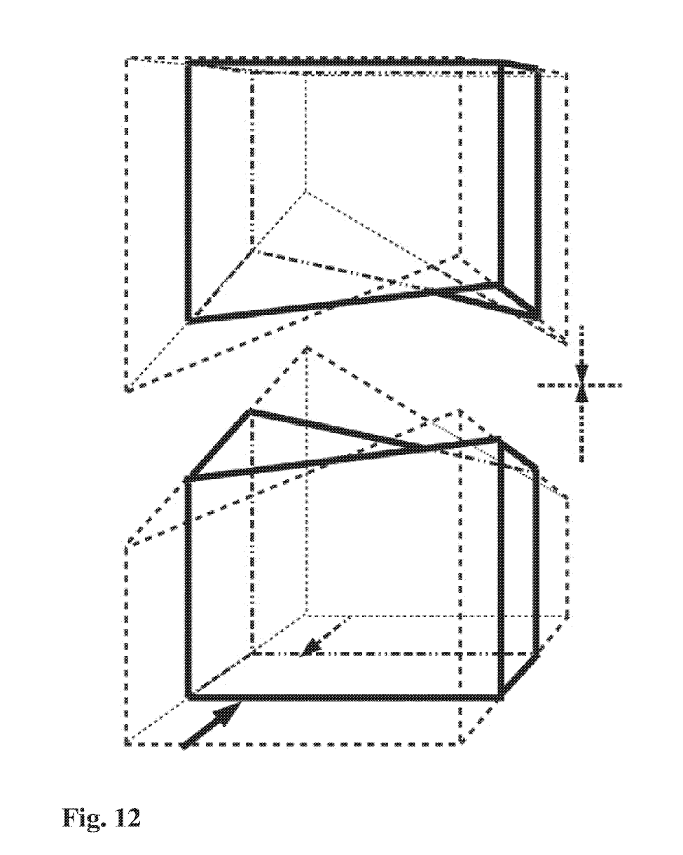

FIG. 12 shows—for the example of only one slot—a design of the imaging device with reduced mass. The thickness (material thickness) of the two slot blocks is reduced (cf. arrows in left part of the image) which results in a reduction in mass of the entire device. A suitable material combination comprises two different materials. One for a (thick) metal sheet directly delimiting the slot along the radiation beam direction is a more strongly absorbing first material which fulfils the function of a “barrier layer”. This barrier layer is shown hatched in FIG. 7. The remaining and predominant part of the slot blocks is formed by a second more weakly absorbing second material. This forms the predominant part of the slot aperture “aperture body” and delimits the slot on one side, on that side which lies opposite the barrier layer of the more strongly absorbing material. The barrier layer can, for example, comprise tungsten whereas copper, brass or bronze are selected as aperture body. In the figure a dashed line guide designates the original slot aperture with full wall thickness whereas the reduction in the wall thickness is indicated by thick continuous lines. The arrows in the plane (left image half) indicate the reduction in the wall thickness made and the perpendicular arrows (right image half) are intended to indicate that the slot is pulled apart in the view for better visualization but is substantially narrower in the operating state.

A design of an imaging device which is adapted for high-energy radiation in the range up to 300 keV has been described above: compared with an imaging device adapted for a range of high-energy radiation around 1 MeV (1 MeV±50 keV), only ⅕ of the shielding thickness is required in this case. In the case of tungsten as shielding material, this corresponds to a reduction in the wall thickness of the first and second slot block of 5 cm to 1 cm. As a result, regardless of the shielding material a weight reduction of about 80% is achieved, e.g. to 30 kg from 150 kg. Compared to an alternatively possible scale reduction of the aperture, the width of the slot aperture (220) is retained in this case (cf. FIG. 12). Only the wall thickness is reduced, where the overall recording geometry from the thick-walled design is retained in principle. With the lighter design it is possible to implement an imaging device comprising the described slot aperture and a detector as portable and therefore capable of being used as mobile. With a suitable carrying frame, the corresponding device can, for example, be carried by an operator, aligned to the object to be studied and operated so that a high-resolution image can also be obtained under complex measurement conditions, possibly under spatially restricted conditions on a fixed object.

With the known slot aperture camera (DE 10 2005 029 674 B4), objects irradiated with an x-ray tube were successfully imaged using Compton backscattering (recently presented at ICNDT 2012: N. Wrobel, K. Osterloh, M. Jechow, U. Ewert: X-ray backscattering: variable irradiation geometry facilitates new insights (cf. http://www.ndt.net/article/wcndt2012/papaers/282_wendtfinal00282.pdf). As a result of the independence of the operating mode of the slot aperture camera on the irradiation geometry with the x-ray emitter, recordings which had hitherto not been successful with the conventional x-ray backscattering method were successful. The backscattering behaviour of individual material layers in the object could be controlled by specific irradiation. It was thus possible to represent radiation-passive components as silhouettes against a radiating background.

In the practical handling of this slot aperture, there was the following problem in the experimental structure: the slot width was configured variably and could be adjusted using a micrometer screw. It was rapidly shown however that with a large opening the images became increasingly blurred but if the aperture opening is too small, too little radiation reaches the detector to obtain an identifiable image. EP 2333786 B1 which has already been granted and which describes an aperture with multiple slots for increasing the imaged area and for increasing the radiation incident on the image detector provides no adjustability of the slot widths. A mechanical mover device for each individual slot would be disproportionately expensive since all the slots must be adjusted synchronously.

Against this background, starting from the finding that the slot aperture need not necessarily be configured mirror-symmetrically in the beam direction, the multiple slot aperture described here is proposed. It is sufficient if each imaging beam is encased somewhere along its path to the image detector as if it were to pass through a collimator. In other words, the aperture body with its beam-selecting property can in principle be located at any point in the beam path. Thus, the central axis through which all the slot planes run need not necessarily be located inside the aperture body but can also be arranged in front or behind. A changed beam passage at this point affects all the slots in the aperture.

It is thus proposed to provide only one mechanical slot width adjustment. The entire aperture accordingly consists of a front and a rear partial aperture (here also designated as slot block) of which one is configured to be movable and the other fixedly installed. There is therefore advantageously no need for an adjusting mechanism which acts on each individual slot. Details of this are explained by reference to the appended figures, in particular the derivation of the proposed slot aperture from the previously known slot aperture in FIG. 3, the functional principle of the new aperture in FIGS. 4 to 7 and an adapted drive mechanism in FIGS. 8 to 10.

At the same time, it cannot be avoided that in the blocked-off part of the beam path the shielding is only accomplished by a partial aperture or only by a slot block but its thickness and/or the material of at least a part of a wall of the metal sheets encasing the slots is selected so that its shielding effect is sufficient for the provided application. In particular, it is shown in FIG. 6 that this circumstance which initially seems disadvantageous can be successfully compensated by using a denser material. According to preferred embodiments, a slot block for example comprises tungsten whilst the other parts of the aperture body comprise or consist of copper or brass.

The proposed solution is based on the fact that the slot aperture need not necessarily be configured to be mirror-symmetrical in the beam direction. It is sufficient if each imaging beam is encased on its path to the image detector as if it were to pass through a collimator. In other words, the aperture body with its beam-selecting property can in principle be located at any point in the beam path. Thus, the central axis through which all the slot planes run need not necessarily be located inside the aperture body but can also be arranged in front or behind. A changed beam passage at this point affects all the slots in the aperture. Therefore only a mechanical slot width adjustment needs to be provided here. The entire aperture accordingly consists of a front and a rear partial aperture (here also designated as slot block) of which one is configured to be movable and the other fixedly installed. A mechanism which acts on each individual slot is therefore superfluous.

In summary, the attained advantages of the proposed embodiments consist in a light-weight design of an aperture for x-ray radiation<400 keV; the forming of the slot apertures from metal sheets instead of by milling from solid material; the easier manufacture of numerous slots in a multiple slot aperture; the division of the entire body into joined-together components; an improved radiation yield due to the presence of several slots; the use of readily mouldable materials for moulding the slots; pouring in absorbing material between pre-formed slots; the possibility of producing all the slots starting from a (larger) initial mould and therefore easier series production of the portable multiple slot aperture.

Further advantages relate to or are based on the division of a solid aperture into partial aperture bodies or slot blocks arranged adjustably with respect to one another; the easy adjustability of several slots by displacement of the partial aperture bodies (slot blocks) with respect to one another; the possibility of easier adaptation to a provided beam intensity; a sharper imaging at sufficient beam intensity; the provision of an adapted adjustment mechanism; a weight reduction with adaptation of the design of the multiple slot aperture to lower beam energies (x-rays); the use of materials having different density; the self-similar design of the slot walls in the overlap region; the wider opening which allows shorter exposure times for an unchanged high image quality.

The previously described embodiments are advantageously suitable
1. for using both actively emitting (gamma radiation emitting) bodies and also high-energy radiation backscattered by unknown investigated objects to generate an image which cannot be detected by a simple pinhole aperture;
2. for enlarging the image area used for imaging by using multiple slots and being able to form slot profiles which eliminate any superposition/multiple exposure by using metal sheets for delimiting the gap with subsequent filling of the intermediate spaces (cf. FIGS. 2, 3);
3. for ensuring the adjustability of the slot width by dividing into partial blocks (cf. FIGS. 4 to 6) where the slot wall which is displaceable in the beam path is strengthened with a thicker material (cf. FIG. 7);
4. for providing a mechanical adjusting device which ensures a reliable adjustment of a desired slot width which is coupled with a suitable drive (cf. FIGS. 9 and 10); and
5. for reliably avoiding parallel passages or multiple exposure when using the multiple slot aperture by selecting multiple slots suitably tilted with respect to one another and a trapezoidal shape of the beam profile through the aperture body, and thus achieving a high imaging quality.

On the one hand therefore a rational lightweight design of a multiple slot aperture is provided for use in Compton backscattering radiography and on the other hand an adjustable version of a multiple slot aperture is provided for adjustment of the exposure in a camera for images with high-energy beams.

In summary, a slot aperture is proposed, in particular for an imaging device which is suitable for delimiting high-energy radiation emanating from a radiation source, in particular x-ray, gamma and/or synchrotron radiation. Furthermore, a method of manufacture for this multiple slot aperture is proposed and its use for imaging representation of a test specimen of unknown material composition. The slot aperture comprises: a first slot block and a second slot block, wherein the first and the second slot block comprises a radiation-absorbing part and at least one radiation-transmitting part. The first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block—in other words: the aperture is open. In a second position of the two blocks the at least one slot of the first slot block points towards a slot-free region of the second slot block so that a radiation beam running through the first slot of the first slot block impinges upon a region of the second slot block adjacent to the corresponding slot and thus does cannot pass through the second slot block. In other words: the aperture is closed. The two slot blocks can be moved precisely to and fro between an opened and a closed position of the aperture so that any attenuation of radiation used for imaging can be smoothly controlled.

The present invention has been explained with reference to exemplary embodiments. These exemplary embodiments should in no way be understood as restrictive for the present invention. The following claims constitute a first non-binding attempt to generally define the invention.

What is claimed is:

1. A slot aperture for an imaging device which is suitable for delimiting high-energy radiation emanating from a radiation source, in particular x-ray, gamma and/or synchrotron radiation, comprising:
a first slot block and a second slot block,
wherein the first and the second slot block comprises a radiation-absorbing part and at least one radiation-transmitting part and the first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block and in a second position the slot of the first slot block points towards a slot-free region of the second slot block so that a radiation beam running through the first slot of the first slot block impinges upon a region of the second slot block adjacent to the corresponding slot and thus does not pass through the second slot block.

2. The slot aperture according to claim 1, wherein the second position corresponds to a parallel shift of the slot of the first slot block to that of the second slot block.

3. The slot aperture according to one of claim 1, wherein an adjoining surface region between the first and an adjacent second slot of the second slot block at least has a shape which is obtained from a projection of the cross-sectional area of the first slot of the first slot block onto the surface of the second slot block facing the first slot block.

4. The slot aperture according to any one of claim 1, wherein one slot comprises at least two opposite walls of at least identical shape in sections.

5. The slot aperture according to claim 4, wherein at least one wall comprises a metal sheet.

6. The slot aperture according to claim 5, wherein the metal sheet is selected from: aluminium, bronze, iron, copper, brass, nickel, steel, titanium, tungsten or an alloy comprising at least one of the elements selected from the group consisting of: Al, Be, Pb, Cu, Cr, Fe, Ni, Sn, Ti, W, and Zn.

7. The slot aperture according to any one of claim 1, wherein the radiation-absorbing part comprises lead which is arranged between the walls of adjacent slots.

8. The slot aperture according to claim 6, wherein a first wall comprises a first metal sheet which has a higher absorption capacity for the high-energy radiation than a metal sheet which is embraced by a second wall.

9. The slot aperture according to claim 8, wherein a thickness and/or a profile of the first metal sheet of the slot in the first block at least comprises a thickness and/or a profile of the corresponding slot in the second slot block and a thickness and/or a profile of the second metal sheet of the slot in the second slot block at least comprises a thickness and/or a profile of the corresponding slot in the first slot block.

10. The slot aperture according to claim 1, wherein at least two of the slots of the same slot block have an identical cross-sectional area and/or shape.

11. The slot aperture according to claim 1, wherein planes defined by the slots in the first slot block intersect one another in a line which lies outside the first slot block on a side facing the second slot block.

12. The slot aperture according to claim 1, wherein the x-ray, gamma and/or synchrotron radiation can be adapted by means of an adjustable slot width of the at least one radiation-transmitting slot so that a suitable fraction of the high-energy radiation for producing an image is incident through the slot aperture.

13. The slot aperture according to claim 1, wherein the high-energy radiation lies in the range of 50 keV to 20 MeV, for example in the range of 150 keV to 1000 keV, typically in the range of 100 keV to 450 keV.

14. The slot aperture according to claim 1, wherein a shielding thickness of the slot aperture is adapted to an energy range of the high-energy radiation of up to 300 keV.

15. The slot aperture according to claim 12, wherein the slot width is adjustable between 1 mm and 7 mm.

16. A method of manufacture for a slot aperture for high-energy radiation comprising:
forming at least two metal sheets on an initial shaped body;
equidistant connection of respectively two metal sheets to one another so that the interconnected metal sheets form a channel, wherein the channel comprises a first open end and a second open end opposite thereto;
arranging and aligning the channel in a casting mould;
filling the casting mould with a lead-containing melt in such a manner that the channel is not filled with the melt; and
removing a casting comprising the channel obtained in the casting mould.

17. The method of manufacture according to claim 16, further comprising:
trueing the casting body to a slot block.

18. The method of manufacture according to claim 17, further comprising:
adapting and aligning a first and a second slot block so that in a first position the at least one slot arranged in the first slot block is continued in precisely one corresponding slot arranged in the second slot block so that a radiation beam running through the first slot of the first slot block passes unhindered through the second slot block and in a second position, the slot of the first slot block points towards a slot-free region of the second slot block so that a radiation beam running through the first slot of the first slot block impinges upon a region of the second slot block adjacent to the corresponding slot and thus does not pass through the second slot block.

19. The method of manufacture according to claim 18, further comprising:
providing a drive for gradual change between the first and the second position so that a resulting power of a radiation beam passing through the first and the second slot block can be adjusted as required.

20. The method of manufacture according to claim 19, further comprising:
arranging an image acquisition system on one side of a slot block so that a radiation beam passing through the slot aperture impinges upon a detecting surface of the image acquisition unit.

21. Use of a slot aperture described according to claim 1 for the imaging representation of a test specimen by means of exposure to high-energy radiation, wherein a radiation source of high-energy radiation, a test specimen and a slot aperture are arranged so that fraction of the high-energy radiation backscattered by the test specimen impinge upon an image acquisition unit and/or on a detector.

22. An image-generating method for non-destructive material testing of an object with high-energy radiation, in particular with x-ray, gamma and/or synchrotron radiation, the method comprising:
providing an imaging device comprising a slot aperture and a detector; wherein the slot aperture includes:
a first slot block and a second slot block,
wherein the first and the second slot block comprises a, radiation-absorbing part and at least one radiation-transmitting part and the first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block and in a second position the slot of the first slot block points towards a slot-free region of the second slot block so that a radiation beam running through the first slot of the first slot block impinges upon a region of the second slot block adjacent to the corresponding slot and thus does not pass through the second slot block,
arranging the imaging device and the object so that high-energy radiation emanating from and/or backscattered by the object is incident through the slot aperture onto the detector of the imaging device;
adjusting a slot width of the slot aperture of the imaging device with regard to a beam intensity so that at the adjusted slot width a fraction of the high-energy radiation emanating from and/or backscattered by the object, suitable for generating an image, is guided onto the detector.

23. The image-generating method according to claim 22, wherein the object comprises a composite material and the non-destructive material testing allows detection of an inclusion and/or an inhomogeneity in the composite material.

24. An imaging device comprising a slot aperture with at least one radiation-transmitting slot and a detector, wherein high-energy radiation, in particular x-ray, gamma and/or synchrotron radiation can be adapted with regard to a beam intensity by means of an adjustable slot width of the at least one radiation-transmitting slot so that at the adjusted slot width high-energy radiation emanating from an actively emitting object and/or backscattered by an unknown object guides a fraction of the high-energy radiation suitable for generating an image through the slot aperture onto the detector,
wherein the slot aperture comprises a first slot block and a second slot block which each comprise a radiation-absorbing part and at least one radiation-transmitting slot and the first and the second slot block can be arranged with respect to one another so that in a first position the at least one slot arranged in the first slot block is continued in precisely one corresponding slot arranged in the second slot block so that a radiation beam running through the first slot of the first slot block passes unhindered through the second slot block and in a second position the slot of the first slot block points towards a slot-free region of the second slot block so that a radiation beam running through the first slot of the first slot block impinges upon a region of the second slot block adjacent to the corresponding slot and thus does not pass through the second slot block.

25. The imaging device according to claim 24, wherein the radiation-transmitting slot comprises at least two opposite walls of identical shape at least in sections.
